(19) United States
(12) Patent Application Publication
(10) Pub. No.: US 2002/0153666 A1
(43) Pub. Date: Oct. 24, 2002

(54) Metal flat gasket

(76) Inventor: Gunther Unseld, Neenstetten (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/981,078

(22) Filed: Oct. 16, 2001

(30) Foreign Application Priority Data
Oct. 17, 2000 (DE) 200 17 774.5
Nov. 23, 2000 (DE) 100 58 087.4

(51) Int. Cl. F02F 11/00

(52) U.S. Cl. 277/593

(57) ABSTRACT

A metal flat gasket is provided that includes at least one sealing plate on which a bead and a deformation limiter for the bead are arranged around at least one through opening. The deformation limiter comprises a thickened part produced by upsetting the edge of the sealing plate in the region of the through opening. The thickness of the deformation limiter is substantially uniform over its entire length.

The invention pertains to a metal flat gasket with at least one sealing plate on which a bead and a deformation limiter (stopper) for the respective bead are arranged around at least one through-opening.

The pressure exerted on a gasket by the sealing surfaces constantly changes particularly in cylinder head gaskets. In order to ensure a flawless sealing function over an extended period of time, it is necessary to use a gasket with the corresponding elastic properties. For example, elastically deformable beads are arranged in metal flat gaskets in order to achieve the desired effects. It is customary to arrange deformation limiters in the immediate vicinity of the beads in flat gaskets of this type in order to prevent the beads from being subjected to excessive plastic deformation. In multilayer metal flat gaskets, these deformation limiters which are also referred to as “stoppers” may be arranged in the metal layer that also contains the respective bead or in the adjacent layers.

Such deformation limiters are usually produced by deforming the given metal layer, which is generally bent or flanged in order to produce the deformation limiter. However, other shaping methods may also be used to produce certain contours and shapes of the deformation limiters.

A metal flat gasket is known from DE 197 31 490 A1. This flat gasket contains at least one layer with at least one through-opening, wherein the through-opening is entirely surrounded by a bead. According to the aforementioned OLS Patent, this bead is thickened by upsetting the gasket edge within the region of the through-opening.

EP 0 747 614 A1 discloses a metal cylinder head gasket in which a carrier plate is sandwiched between two cover plates. On the side of the combustion chamber, the carrier plate contains a convex thickened part with radii of curvature sufficient to prevent high edge pressures.

However, it was determined that the previously described flat gasket is not yet suitable to equalize the pressure distribution sufficiently and to reduce the dynamics of the gap to be sealed.

Thus, in light of the foregoing, the present invention has the objective of making available an improved metal flat gasket with a deformation limiter for beads which can be easily and inexpensively manufactured and simultaneously ensures equalization of the pressure distribution.

According to the invention, this objective is realized with a metal flat gasket according to claim 1. Advantageous embodiments and additional refinements of the invention can be realized with the characteristics disclosed in the subordinate claims.

The metal flat gasket according to the invention consists of at least one sealing plate, wherein at least one bead is arranged on and around a through-opening. A deformation limiter (stopper) for the corresponding bead is provided on the sealing plate or an additional sealing plate. In addition to the aforementioned sealing plate, a second sealing plate may be provided on the underside (three-layer gasket). A bead may also be arranged on the second sealing plate.

The deformation limiter arranged on the sealing plate is obtained by means of an upsetting process starting from the edge facing the given through-opening. Due to the upsetting process, the thickening of the plate material is achieved without requiring additional material or without a bending or flanging process. It is essential that the thickness of the stopper be uniform over its entire length, and that the entire thickening process be performed at one time. The deformation itself can be realized in the form of recesses, grooves, beads and/or fluting.

The deformation limiter may be produced by rigidly clamping the plate in position and exerting a radially acting compressive force upon the edge of the plate such that a thickening of the edge region is achieved. In this case, the opening in the semifinished plate should have a smaller size than that of the through-opening before the upsetting process.

The plate material is upset and deformed in such a way that the deformation limiter has a greater thickness than that of the respective sealing plate.

After the upsetting process, a deformation of the plate material is produced in the region of the deformation limiter such that the deformation limiter can be plastically as well as elastically deformed. The deformation limiter thereby obtained is also able to fulfill a certain part of the bead function in addition to its function of limiting the deformation. The deformation can also be produced simultaneously with the upsetting process.

The deformation can be produced in accordance with the desired deformation contour by pressing tools that contain negative contours against the plate from both sides. During the deformation, the displaced metal flows into the contours. In this way, the deformation limiter can not only be realized in the form of a thickening, but also deformed in a targeted fashion.

The deformation limiter can be arranged in the form of a ring around one or more through-openings, wherein the respective rings may be realized in the form of groove-shaped recesses, as well as corresponding projections, preferably with sector-shaped or sinusoidal cross sections.

It is also possible to arrange several such rings (recesses or projections) around a through-opening in the radial direction such that the plastic and elastic properties are further improved.

The height and the depth of the recesses or projections arranged adjacent to one another may be chosen differently. In this case, a different elasticity limit of the beads and a different elasticity and plasticity in the various regions of such a deformation limiter can be achieved.

In the metal flat gasket according to the invention, a superior adaptation to different component thicknesses and to constant pressure changes can be achieved, in particular, when the metal flat gasket is used as a cylinder head gasket. Since the bead(s) has/have durable elastic properties, a flawless sealing function can be ensured over an extended period of time.

The thickened part (increased height) that represents the deformation limiter according to the invention makes it possible, in connection with one or two active beads, to achieve a seal over the entire circumference of the through-opening with no excessive deformation.

Due to the plastic and elastic deformability of the deformation limiter, a uniform pressure distribution can be achieved around a through-opening. Only a very slight pressure drop occurs in the region located between cylinder head screws, and the dynamic of the movement of the metal flat gasket and consequently the dynamics of the gap to be sealed are also significantly reduced.

The invention is described in greater detail below with reference to various embodiments.

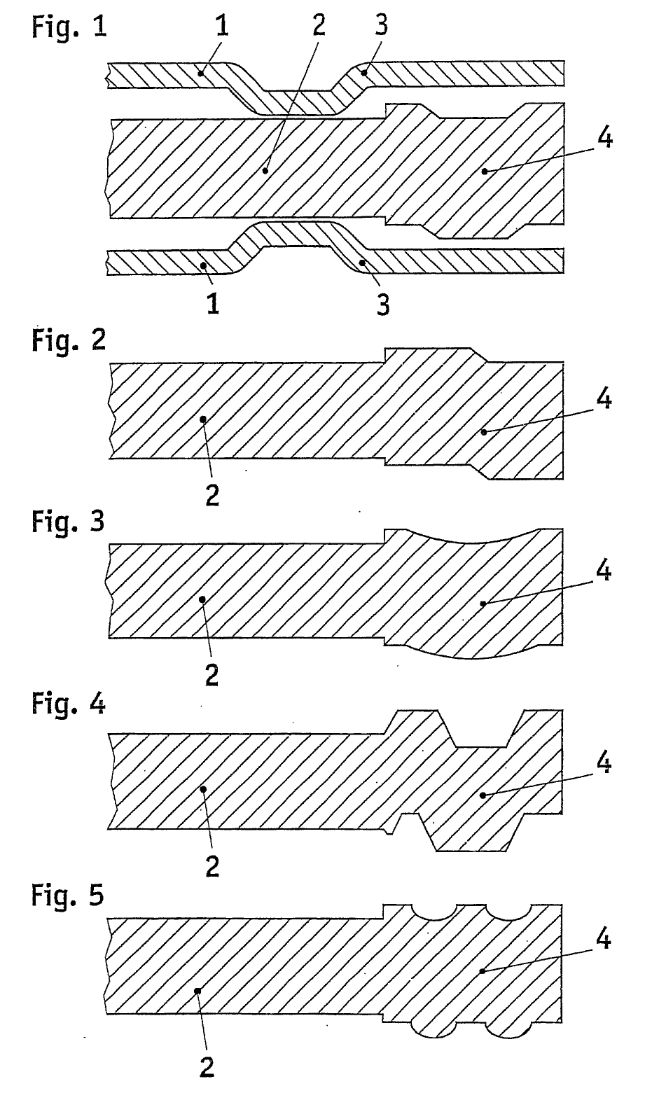

FIGS. 1-5 show examples of carrier plates with deformation limiters which were deformed in different ways.

In the embodiments shown in FIGS. 1-5, differently designed deformation limiters 4 were produced by upsetting and deforming a carrier plate 2.

FIG. 1 shows part of a three-layer metal flat gasket that consists of two sealing plates 1 which respectively contain a bead 3 and a carrier plate 2 arranged between the sealing plates.

The arrow pointing to the left indicates that the edge of the carrier plate 2 which points in the direction of the through-opening in the gasket was upset and subsequently or simultaneously deformed. A thickened part is formed on the carrier plate 2 due to the displacement of material. During the upsetting process, the carrier plate 2 is also rigidly clamped in position outside the section to be upset, wherein a thickening of the plate material is achieved during the upsetting process. The upsetting process and the deformation process result in the ability to deform the deformation limiter 4 elastically as well as plastically, as described above in the general portion of the description.

In the embodiment according to FIG. 1, a groove-shaped annular recess is arranged around the through-opening on the upper side of the carrier plate 2, with a corresponding projection, also annular, simultaneously formed on the underside due to the deformation of the carrier plate material.

This figure, as well as the others, clearly shows that the thickness of the deformation limiter 4 is greater than in the region of the plate 2 which was not subjected to an upsetting process. However, sufficient free space remains for a certain elastic deformation of the beads 3.

In the embodiment according to FIG. 2, only the shape of the deformation limiter 4 is chosen differently. Here, thickened projections are produced in an offset arrangement on the carrier plate 2, i.e., on both sides of the carrier plate 2 or a sealing plate, e.g., in a single-layer metal flat gasket.

The deformation limiter 4 shown in FIG. 3 has a groove-shaped recess of convex form on its upper side and a concave projection on its underside. Such a deformation limiter 4 may also be concave on both sides.

In the embodiment according to FIG. 4, the deformation limiter 4 is formed by meandering, beveled recesses and projections, wherein the recesses and projections alternate on one side of the carrier plate 2:

In the embodiment according to FIG. 5, the deformation limiter 4 is realized in the form of two recesses in the form of grooves or rings arranged adjacent to one another on its upper side, with the underside being realized with correspondingly rounded projections in the form of a concave and convex fluting. The concave and convex fluting can also be provided on both sides.

The illustration of at least one additional sealing plate 1 was omitted in the embodiments shown in FIGS. 2-5. However, a metal flat gasket may contain at least one additional sealing plate 1. In this case, bead shapes other than those illustrated in FIG. 1 may also be used.

Specifically, in the embodiments shown in FIGS. 4 and 5, the height and the depth of the projections and recesses, respectively, on the deformation limiter 4 may also vary radially outward from the through-opening. Thus, the respective height and the depth of the projections and grooves arranged in the direction of the through-opening could be greater than the height and the depth further toward the outside. However, it would also be possible to choose different height and depth ratios.

1. Metal flat gasket, containing at least one sealing plate on which a bead and a deformation limiter (stopper) for the bead which is located on the gasket edge are arranged around at least one through-opening, wherein the stopper is realized in the form of a thickened part produced by upsetting the edge of the sealing plate in the region of the through-opening, characterized by the fact that the thickness of the stopper (4) is essentially uniform over its entire length, and by the fact that deformations produced with a shaping tool are arranged in the thickened part.

2. Metal flat gasket according to claim 1, characterized by the fact that the deformations are realized in the form of recesses, grooves, beads and/or fluting.

3. Metal flat gasket according to claim 1 or 2, characterized by the fact that the stopper (4) has a convex and/or concave form.

4. Metal flat gasket according to claim 1 or 2, characterized by the fact that the stopper (4) is realized in the form of convex and/or concave fluting.

5. Metal flat gasket according to claim 1 or 2, characterized by the fact that the stopper (4) is realized in the form of recesses and elevations.

6. Metal flat gasket according to one of claims 1-5, characterized by the fact that the sealing plate (2) is covered by additional sealing plates (1) on both sides.

7. Metal flat gasket according to claim 1 or 2, characterized by the fact that beads (3) are provided on both sealing plates (1).
